(19) United States
(12) Patent Application Publication
(10) Pub. No.: US 2024/0185168 A1
(43) Pub. Date: Jun. 6, 2024

(54) ELECTRONIC SYSTEM FOR MONITORING AND AUTOMATICALLY CONTROLLING CARGO TRANSPORTATION

(71) Applicant: BLUME GLOBAL, INC., Pleasanton, CA (US)

(72) Inventors: Pervinder JOHAR, Pleasanton, CA (US); Santosh PANT, Dublin, CA (US)

(73) Assignee: BLUME GLOBAL, INC., Pleasanton, CA (US)

(21) Appl. No.: 18/282,614

(22) PCT Filed: Mar. 24, 2022
(86) PCT No.: PCT/US2022/021654

§ 371 Date: Sep. 18, 2023

Related U.S. Application Data
(60) Provisional application No. 63/166,746, filed on Mar. 26, 2021.

(51) Int. Cl. G06Q 10/0833; G06Q 10/0835

(52) U.S. Cl. CPC G06Q 10/0833; G06Q 10/08355

(57) ABSTRACT

Various systems, methods, and computer program products are provided for monitoring and automatically controlling cargo transportation. The method includes receiving a shipment tracking inquiry including at least an origination location and a destination location. The method also includes generating at least one shipment route. The method further includes receiving real-time cargo transportation indicator(s) along at least one of the at least one shipment routes. The one or more real-time cargo transportation indicators indicate a status of one or more shipments on at least one of the at least one shipment route. The method still further includes determining a preferred shipment route of the at least one shipment route based on the one or more real-time cargo transportation indicators. The method also includes causing a display device to display a rendering of a representation of the preferred shipment route.

### CROSS-REFERENCE TO RELATED APPLICATION

This patent application claims the benefit of U.S. Provisional Application No. 63/166,746 filed on Mar. 26, 2021, the disclosure of which is incorporated herein by reference in its entirety.

### FIELD OF THE INVENTION

The present disclosure relates generally to monitoring cargo transportation, and more particularly to an electronic system for monitoring and automatically controlling cargo transportation.

### BACKGROUND

Cargo transportation can often be delayed due to inefficiencies in tracking and control. Many shipments must go through multiple locations between the shipping location and the destination location. Each stop along a route has the capability to cause a delay to the shipment transportation. Delays in shipments can create supply chain issues. Therefore, there exists a need for a system that can monitor and control cargo transportation.

### BRIEF SUMMARY

The following presents a summary of certain embodiments of the disclosure. This summary is not intended to identify key or critical elements of all embodiments nor delineate the scope of any or all embodiments. Its sole purpose is to present certain concepts and elements of one or more embodiments in a summary form as a prelude to the more detailed description that follows

In an example embodiment, a system is provided for monitoring and automatically controlling cargo transportation. The system includes at least one non-transitory storage device and at least one processing device coupled to the at least one non-transitory storage device. The at least one processing device is configured to receive a shipment tracking inquiry. The shipment tracking inquiry includes at least an origination location and a destination location. The at least one processing device is also configured to generate at least one shipment route based on the shipment tracking inquiry. The at least one processing device is further configured to receive one or more real-time cargo transportation indicators along at least one of the at least one shipment route. The one or more real-time cargo transportation indicators indicate a status of one or more shipments on at least one of the at least one shipment route. The at least one processing device is still further configured to determine a preferred shipment route of the at least one shipment route based on the one or more real-time cargo transportation indicators. The preferred shipment route is at least one of a fastest route of the at least one shipment route or a shortest route of the at least one shipment route. The at least one processing device is also configured to cause a display device to display a rendering of a representation of the preferred shipment route.

In some embodiments, a first shipment route of the at least one shipment route is at least one of a first shipment type and a second shipment route of the at least one shipment route is at least one of a second shipment type, wherein the first shipment type is different from the second shipment type. In some embodiments, the first shipment type and the second shipment type are each at least one of a rail transport, a road transport, an air transport, or a water transport.

In some embodiments, the one or more real-time cargo transportation indicators includes at least one of a route information for another shipment along the given shipment route. In some embodiments, the at least one processing device is further configured to determine a shipment route reliability rating for at least one of the shipment routes based on at least one historical shipment indicator relating to the shipment route or carrier of the shipment route.

In some embodiments, the at least one processing device is further configured to change the preferred shipment route from a first shipment route of the at least one shipment route to a second shipment route of the at least one shipment route based on one or more real-time cargo transportation indicators.

In some embodiments, the at least one processing device is further configured to determine at least one location-based performance indicator for one or more locations with each location-based performance indicator indicates the time taken for one or more shipments travelling through a given location of the one or more locations and update the preferred route based on at least one of the at least one location-based performance indicators.

In some embodiments, the at least one processing device is further configured to cause a rendering of a display of the location-based performance indicators for at least one of the one or more locations.

In some embodiments, the at least one processing device is further configured to cause a rendering of a display with information relating to at least one of the at least one shipment route and receive a route selection input that selects one of the at least one rendered shipment route, wherein the preferred shipment route is updated based on the route selection input.

In some embodiments, the at least one of the one or more real-time cargo transportation indicators is based on global position system (GPS) data, automatic identification system (AIS) data, car location message (CLM) data, and/or electronic logging device (ELD) data.

In another example embodiment, a computer program product for monitoring and automatically controlling cargo transportation. The computer program product includes at least one non-transitory computer-readable medium having computer-readable program code portions embodied therein. The computer-readable program code portions include an executable portion configured to receive a shipment tracking inquiry. The shipment tracking inquiry includes at least an origination location and a destination location. The computer-readable program code portions further include an executable portion configured to generate at least one shipment route based on the shipment tracking inquiry. The computer-readable program code portions still further include an executable portion configured to receive one or more real-time cargo transportation indicators along at least one of the at least one shipment route. The one or more real-time cargo transportation indicators indicate a status of one or more shipments on at least one of the at least one shipment route. The computer-readable program code portions also include an executable portion configured to determine a preferred shipment route of the at least one shipment route based on the one or more real-time cargo transportation indicators. The preferred shipment route is at least one of a fastest route of the at least one shipment route or a shortest route of the at least one shipment route. The computer-readable program code portions further include an executable portion configured to cause a display device to display a rendering of a representation of the preferred shipment route to a user interface.

In some embodiments, a first shipment route of the at least one shipment route is at least one of a first shipment type and a second shipment route of the at least one shipment route is at least one of a second shipment type, wherein the first shipment type is different from the second shipment type. In some embodiments, the first shipment type and the second shipment type are each at least one of a rail transport, a road transport, an air transport, or a water transport.

In some embodiments, the one or more real-time cargo transportation indicators includes at least one of a route information for another shipment along the given shipment route. In some embodiments, the computer-readable program code portions include an executable portion configured to a shipment route reliability rating for at least one of the shipment routes based on at least one historical shipment indicator relating to the shipment route or carrier of the shipment route.

In some embodiments, the computer-readable program code portions include an executable portion configured to change the preferred shipment route from a first shipment route of the at least one shipment route to a second shipment route of the at least one shipment route based on one or more real-time cargo transportation indicators.

In some embodiments, the computer-readable program code portions include an executable portion configured to determine at least one location-based performance indicator for one or more locations with each location-based performance indicator indicates the time taken for one or more shipments travelling through a given location of the one or more locations and an executable portion configured to updating the preferred route based on at least one of the at least one location-based performance indicators.

In some embodiments, the computer-readable program code portions include an executable portion configured to cause a rendering of a display of the location-based performance indicators for at least one of the one or more locations.

In some embodiments, the computer-readable program code portions include an executable portion configured to cause a rendering of a display with information relating to at least one of the at least one shipment route and receive a route selection input that selects one of the at least one rendered shipment route, wherein the preferred shipment route is updated based on the route selection input.

In some embodiments, at least one of the one or more real-time cargo transportation indicators is based on global position system (GPS) data, automatic identification system (AIS) data, car location message (CLM) data, and/or electronic logging device (ELD) data.

In yet another example embodiment, a computer-implemented method for monitoring and automatically controlling cargo transportation. The method includes receiving a shipment tracking inquiry. The shipment tracking inquiry includes at least an origination location and a destination location. The method also includes generating at least one shipment route based on the shipment tracking inquiry. The method further includes receiving one or more real-time cargo transportation indicators along at least one of the at least one shipment route. The one or more real-time cargo transportation indicators indicate a status of one or more shipments on at least one of the at least one shipment route. The method still further includes determining a preferred shipment route of the at least one shipment route based on the one or more real-time cargo transportation indicators. The preferred shipment route is at least one of a fastest route of the at least one shipment route or a shortest route of the at least one shipment route. The method also includes causing a display device to display a rendering of a representation of the preferred shipment route.

In some embodiments, a first shipment route of the at least one shipment route is at least one of a first shipment type and a second shipment route of the at least one shipment route is at least one of a second shipment type and the first shipment type is different from the second shipment type. In some embodiments, the first shipment type and the second shipment type are each at least one of a rail transport, a road transport, an air transport, or a water transport.

In some embodiments, the one or more real-time cargo transportation indicators includes at least one of a route information for another shipment along the given shipment route.

In some embodiments, the method also includes determining a shipment route reliability rating for at least one of the shipment routes based on at least one historical shipment indicator relating to the shipment route or carrier of the shipment route. In some embodiments, the method also includes changing the preferred shipment route from a first shipment route of the at least one shipment route to a second shipment route of the at least one shipment route based on one or more real-time cargo transportation indicators.

In some embodiments, the method also includes determining at least one location-based performance indicator for one or more locations with each location-based performance indicator indicates the time taken for one or more shipments travelling through a given location of the one or more locations and updating the preferred route based on at least one of the at least one location-based performance indicators.

In some embodiments, the method also includes causing a rendering of a display of the location-based performance indicators for at least one of the one or more locations. In some embodiments, the method also includes causing a rendering of a display with information relating to at least one of the at least one shipment route and receiving a route selection input that selects one of the at least one rendered shipment route with the preferred shipment route being updated based on the route selection input.

In some embodiments, at least one of the one or more real-time cargo transportation indicators is based on global position system (GPS) data, automatic identification system (AIS) data, car location message (CLM) data, and/or electronic logging device (ELD) data.

Embodiments of the present disclosure address the above needs and/or achieve other advantages by providing apparatuses (e.g., a system, computer program product and/or other devices) and methods for monitoring and automatically controlling cargo transportation. The system embodiments may comprise one or more memory devices having computer readable program code stored thereon, a communication device, and one or more processing devices operatively coupled to the one or more memory devices, wherein the one or more processing devices are configured to execute the computer readable program code to carry out said embodiments. In computer program product embodiments of the disclosure, the computer program product comprises at least one non-transitory computer readable medium comprising computer readable instructions for carrying out said embodiments. Computer implemented method embodiments of the disclosure may comprise providing a computing system comprising a computer processing device and a non-transitory computer readable medium, where the computer readable medium comprises configured computer program instruction code, such that when said instruction code is operated by said computer processing device, said computer processing device performs certain operations to carry out said embodiments.

### BRIEF DESCRIPTION OF THE DRAWINGS

Having thus described embodiments of the disclosure in general terms, reference will now be made the accompanying drawings, wherein:

FIG. 1 provides a block diagram illustrating a system environment for monitoring and automatically controlling cargo transportation within a technical environment, in accordance with embodiments of the present disclosure:

FIG. 2 illustrates an example process framework for monitoring and automatically controlling cargo transportation in accordance with embodiments of the present disclosure:

FIG. 3 illustrates an example process framework for monitoring location health in accordance with embodiments of the present disclosure:

FIG. 4 illustrates an example process framework for determining shipment route reliability and carrier reliability in accordance with embodiments of the present disclosure:

FIG. 5 illustrates an example process framework for determining product lead time based on shipment route estimates in accordance with embodiments of the present disclosure:

FIG. 6 illustrates an example process framework for determining a preferred shipment route in accordance with embodiments of the present disclosure:

FIG. 7 illustrates an example process framework for performing real-time tracking of a shipment in accordance with embodiments of the present disclosure:

FIG. 8 illustrates an example process framework for performing real-time estimation of a shipment location in accordance with embodiments of the present disclosure:

FIG. 9 illustrates an example user interface displaying the location health of a plurality of locations on a map in accordance with embodiments of the present disclosure:

FIG. 10 illustrates an example user interface displaying the terminal health of a plurality of terminals in accordance with embodiments of the present disclosure:

FIG. 11 illustrates an example user interface displaying the real-time vessel location at a given location in accordance with embodiments of the present disclosure:

FIG. 12 illustrates an example user interface in which multiple potential shipment routes are displayed in accordance with embodiments of the present disclosure; and

FIG. 13 illustrates a flow chart of the method of monitoring and automatically controlling cargo transportation in accordance with an embodiment of the present disclosure.

### DETAILED DESCRIPTION OF EMBODIMENTS OF THE DISCLOSURE

Embodiments of the present disclosure will now be described more fully hereinafter with reference to the accompanying drawings and appendix, in which some, but not all, embodiments of the disclosure are shown. Indeed, the disclosure may be embodied in many different forms and should not be construed as limited to the embodiments set forth herein: rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

Route planning of various embodiments discussed herein can improve supply chain efficiencies for various reasons. For example, the amount of daily planning efforts can be reduced since the route planning can be partially or completely automated. Additionally, the automated route planning of various embodiments can make for more efficient routes (e.g., lower mileage, reduced fuel usage, reduced carbon emissions, etc.). Additionally, the route planning can be dynamically updated, and cargo transport can be optimized (e.g., centralized scheduling can help to consolidate shipments and identify other opportunities for streamlining shipment processes).

Some embodiments described herein provide a system, a computer program product, and/or a method for monitoring and automatically controlling cargo transportation. For example, a system (e.g., an electronic system for monitoring and automatically controlling cargo transportation and/or the like) may use artificial intelligence (AI) and/or machine learning in a systematic way to build a framework to monitor supply chains and generate, in real-time, instructions, recommendations, status updates, and/or the like relating to the transportation of goods. In some embodiments, the system may be an AI system and/or a machine learning system configured to learn the structure, schedules, paces, and/or the like of lanes, routes, and/or shipments as it monitors the supply chains. By using AI and/or machine learning to monitor and learn, the system may become more efficient over time and may generate instructions, recommendations, status updates, and/or the like to achieve faster shipping, reduced costs, reduced environmental impacts (e.g., CO₂ emissions), and/or the like. In some embodiments, the system may combine historical data on a lane with routes, schedules (when available) and current situational data to predict the leadtime for a route. The leadtime can change due to situational data until the shipment starts the journey. Additionally, or alternatively, the system may provide real-time visibility by providing continuously updated location data and Estimated Time of Arrival (ETA) based on an algorithm taking into consideration current location, situational data, and location and progress of shipments on the same or a similar route ahead of the shipment being monitored. In some embodiments, the system may determine if the shipment is early or late, and, based on determining if the shipment is early or late, recommend and/or automatically select alternate mode, route, and/or carrier options to get the shipment back on track taking into consideration the cost of making the change.

In this way, the system may minimize and/or eliminate manual shipment monitoring, which conserves resources (e.g., financial resources, computing resources, network resources, and/or the like) that would otherwise be consumed by manual monitoring. Furthermore, the system may minimize and/or eliminate human-driven errors, which further conserves resources (e.g., financial resources, computing resources, network resources, and/or the like). Additionally, or alternatively, the system may minimize and/or eliminate the need for complex schedules of global teams of support users in multiple time zones to monitor shipments, which further conserves resources (e.g., financial resources, computing resources, network resources, and/or the like). By using AI and/or machine learning to monitor and learn, the system may be more reliable, more stable, and/or more scalable than manual monitoring of shipments, which further conserves resources (e.g., financial resources, computing resources, network resources, and/or the like).

In some embodiments, the system may remove waste from global logistics, thereby reducing cost and increasing sustainability (e.g., reducing or eliminating empty miles, empty container repositioning, optimizing MOT's, optimizing routes (miles/km reduction)). Additionally, or alternatively, the system may be part of a digital operating platform used in international transportation management and/or transportation asset management that enables visibility for freight forwarders to move cargo into and out of airports, seaports, rail ramps, and/or the like.

In some embodiments, the system may provide an API enabled digital operating platform with a new and modern user interface and mobile apps. Additionally, or alternatively, the system may monitor and/or automatically control cargo transportation for carriers, such as ocean and airlines, motor carriers (FTL+LTL+dray), railroads, barges, parcel express, and/or the like. In some embodiments, the system may monitor and/or automatically control assets in marine terminals, airports, rail ramps, factories, distribution centers, container freight stations, cross docks, and many other supply chain related locations. Additionally, or alternatively, the system may utilize data including schedules, end-to-end routes, transportation lead times, and carrier and terminal performance metrics.

In some embodiments, the system may include a digital operating platform that includes an ecosystem of trading partners with associated contacts and locations to efficiently run a supply chain and may be a decision-making system. Additionally, or alternatively, the system may provide supply chain orchestration around the world. For example, the system may integrate trading partners (e.g., customers, buyers, suppliers, ocean, rail, and/or motor carriers, logistics providers, and/or the like) enabling inter-company processes, synchronization and collaboration from forecast through fulfillment, and payment including forecast/procure to pay and forecast/order to cash.

In some embodiments, the system may include a network of locations, carriers, routes, and schedules that may be a digital twin of the physical supply chain. For example, trading partners may include ocean and air freight forwarders, Intermodal Marketing Companies (IMC's), ocean, air freight and FTL, LTL and Dray motor carriers, parcel carriers, barges, and railroads. As another example, locations may include places where products are manufactured, shipped and received including factories, distribution centers, marine terminals, rail ramps, airports, container freight stations, cross-docks, fulfillment centers, container yards, and/or the like.

In some embodiments, route intelligence may provide many routes between origin and destination with the merits of each route (e.g., dynamic lead time, modes, routes including all interim locations, and/or the like). Additionally, or alternatively, location intelligence may provide a continuously updated location of cargo and ETA to destination and characteristics of each physical location in the route, such as dwell time at terminals (e.g. ports, rail terminals and/or the like), terminal throughput, strikes at terminals, and/or the like. In some embodiments, schedule intelligence may provide ocean, air, and railroad schedules directly from carriers. For example, the system may provide schedules, actuals, and performance metrics.

Transit time on a route may change dynamically (e.g., due to seasonality, weather impacts, and/or the like). In some embodiments, the system may, using AI and/or one or more machine learning models, constantly calculate exact locations and/or changes in ETAS.

In some embodiments, the system may connect the supply chain ecosystem (e.g., trading partners including carriers, logistics service providers, customer and suppliers, seaports, airport ground handling, rail ramps, factories, distribution centers, and/or the like). Additionally, or alternatively, the system may layer on top of a network providing intelligent schedules, locations, and routes enabling users to plan and track shipments along with understanding when there may be issues. They system may provide alternate modes and routes to take advantage of opportunities and/or resolve issues.

In some embodiments, the system may include an order collaboration function to enable supply chain participants (e.g., customers, buyers, suppliers, ocean, rail, and/or motor carriers, logistics providers, and/or the like) to track demand, forecasts, and/or purchase orders, from the time they are placed until they are fulfilled identifying opportunities and/or issues throughout the life cycle. Using the system, buyers may produce forecasts and/or orders, suppliers may consume and/or respond (e.g., commit, reject, or propose alternative options) to forecasts and/or orders, and logistics providers have visibility to enable developing better logistics plans and/or reserve capacity at favorable pricing.

In some embodiments, the system may include a supply chain visibility function that provides end-to-end shipment visibility with real-time updates to location and/or ETA. For example, the system may provide visibility into orders, items, and/or shipments, such as locations of orders, how much inventory is in transit and/or when will it arrive at the destination. As another example, the system may track cargo quality including temperature, security, and/or damage by integrating sensor data when available. As yet another example, the system may provide a trading partner portal enabling customers and suppliers to have the same level of visibility improving customer support and reducing customer support costs.

In some embodiments, the system may include a holistic TMS function enabling customers to manage carrier and LSP contracts, automatically or manually select the most appropriate carrier(s) for a shipment, book air, ocean and railroad capacity, execute moves using electronic AWB (Air) and BoL (Ocean), track end-to-end including receiving electronic POD, process and pay invoices (freight audit and payment), and/or the like. For example, the system may include an international TMS function providing a full featured TMS supporting ocean, air, rail, FTL, LTL, Dray and parcel express. In some embodiments, customers may use a subset of the system's TMS to complement their existing TMS. Typically, smaller trucking companies cannot connect digitally. The system may provide a platform to enable motor carriers located almost anywhere in the world to connect digitally to receive tenders, track status, provide electronic proof of delivery, and/or supply a digital invoice.

In some embodiments, the system may provide a control tower function that captures data from different enterprise systems using rules and/or AI to look for opportunities and exceptions. For example, the system may collaborate with the right person (at the right organization within the right company) at the right time viewing the same data to take advantage of the opportunities or resolve the issues. As another example, the system may recommend courses of action to take advantage of opportunities and/or resolve issues which can be discussed in the collaboration and/or automatically applied, using machine learning, if the users have a history of taking a specific action.

In some embodiments, the system may include a digital operating platform that is a fully integrated multi-modal TMS, from forecasting and booking to final freight audit and pay, as well as other functionality related to logistics execution, (predictive) milestone visibility and asset and route optimization. In some embodiments, the system provides an end-to-end ecosystem including connected trading partners and associated contacts (pricing, terms, and conditions) required to efficiently run a logistics supply chain. Additionally, or alternatively, if a prospect has an ERP/TMS solution already, the existing ERP/TMS solution may be connected to the digital operating platform via a single interface, offering additional functionality such as logistics execution, (predictive) milestone visibility, asset and route optimization and freight audit and pay. In some embodiments, the digital operating platform may be extended by a ‘white-label’ Customer and/or Supplier Portal.

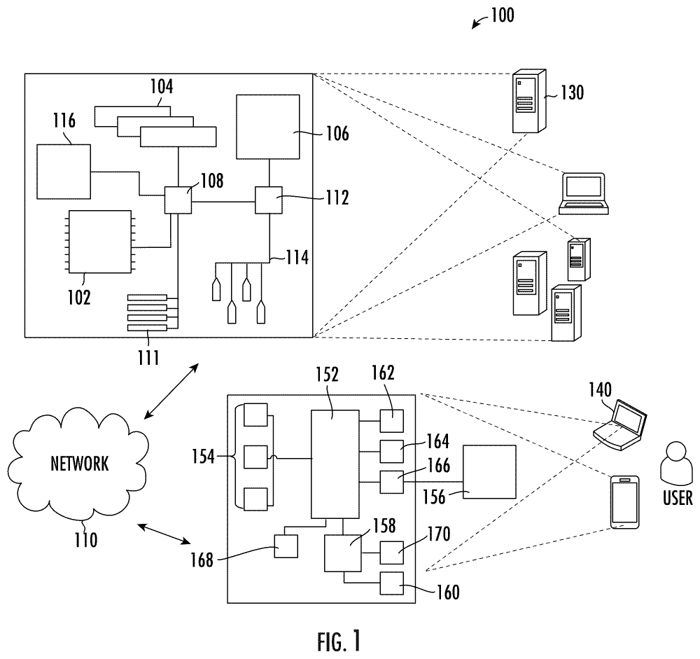

FIG. 1 presents an exemplary block diagram of a system environment 100 for monitoring and automatically controlling cargo transportation within a technical environment, in accordance with an embodiment of the disclosure. FIG. 1 provides a system environment 100 that includes specialized servers and a system communicably linked across a distributive network of nodes required to perform functions of process flows described herein in accordance with embodiments of the present disclosure.

As illustrated, the system environment 100 includes a network 110, a system 130, and a user input system 140. Also shown in FIG. 1 is a user of the user input system 140. The user input system 140 may be a mobile device, a non-mobile computing device, and/or the like. The user may be a person who uses the user input system 140 to access, view, modify, interact with, and/or the like information, data, images, video, and/or the like. The user may be a person who uses the user input system 140 to initiate, perform, monitor, analyze the results of, and/or the like shipments as provided by one or more applications (e.g., stored thereon). The one or more applications may be configured to communicate with the system 130, execute shipment monitoring, input information onto a user interface presented on the user input system 140, and/or the like. The applications stored on the user input system 140 and the system 130 may incorporate one or more parts of any process flow described herein.

As shown in FIG. 1, the system 130 and the user input system 140 are each operatively and selectively connected to the network 110, which may include one or more separate networks. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology.

In some embodiments, the system 130 and the user input system 140 may be used to implement processes described herein, including user-side and server-side processes for monitoring and automatically controlling cargo transportation, in accordance with an embodiment of the present disclosure. The system 130 may represent various forms of digital computers, such as laptops, desktops, workstations, personal digital assistants, servers, blade servers, mainframes, and/or the like. The user input system 140 may represent various forms of mobile devices, such as personal digital assistants, cellular telephones, smartphones, smart glasses, and/or the like. The components shown here, their connections, their relationships, and/or their functions, are meant to be exemplary only, and are not meant to limit implementations of the inventions described and/or claimed in this document.

In some embodiments, the system 130 may include a processor 102, memory 104, a storage device 106, a high-speed interface 108 connecting to memory 104, high-speed expansion ports 111, and a low-speed interface 112 connecting to low-speed bus 114 and storage device 106. Each of the components 102, 104, 106, 108, 111, and 112 may be interconnected using various buses, and may be mounted on a common motherboard or in other manners as appropriate. The processor 102 may process instructions for execution within the system 130, including instructions stored in the memory 104 and/or on the storage device 106 to display graphical information for a GUI on an external input/output device, such as a display 116 coupled to a high-speed interface 108. In some embodiments, multiple processors, multiple buses, multiple memories, multiple types of memory, and/or the like may be used. Also, multiple systems, same or similar to system 130 may be connected, with each system providing portions of the necessary operations (e.g., as a server bank, a group of blade servers, a multi-processor system, and/or the like). In some embodiments, the system 130 may be managed by an entity, such as a business, a merchant, a financial institution, a transportation management institution, a shipping company, and/or the like. The system 130 may be located at a facility associated with the entity and/or remotely from the facility associated with the entity.

The memory 104 may store information within the system 130. In one implementation, the memory 104 may be a volatile memory unit or units, such as volatile random-access memory (RAM) having a cache area for the temporary storage of information. In another implementation, the memory 104 may be a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 may be capable of providing mass storage for the system 130. In one aspect, the storage device 106 may be or contain a computer-readable medium, such as a floppy disk device, a hard disk device, an optical disk device, a tape device, a flash memory and/or other similar solid state memory device, and/or an array of devices, including devices in a storage area network or other configurations. A computer program product may be tangibly embodied in an information carrier. The computer program product may also contain instructions that, when executed, perform one or more methods, such as those described herein. The information carrier may be a non-transitory computer-readable or machine-readable storage medium, such as the memory 104, the storage device 106, and/or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel and/or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, the memory may appear to be allocated from a central pool of memory, even though the memory space may be distributed throughout the system. Such a method of dynamically allocating memory provides increased flexibility when the data size changes during the lifetime of an application and allows memory reuse for better utilization of the memory resources when the data sizes are large.

The high-speed interface 108 may manage bandwidth-intensive operations for the system 130, while the low-speed interface 112 and/or controller manages lower bandwidth-intensive operations. Such allocation of functions is exemplary only. In some embodiments, the high-speed interface 108 is coupled to memory 104, display 116 (e.g., through a graphics processor or accelerator), and to high-speed expansion ports 111, which may accept various expansion cards (not shown). In some embodiments, low-speed interface 112 and/or controller is coupled to storage device 106 and low-speed bus 114 (e.g., expansion port). The low-speed bus 114, which may include various communication ports (e.g., USB, Bluetooth, Ethernet, wireless Ethernet), may be coupled to one or more input/output devices, such as a keyboard, a pointing device, a scanner, and/or a networking device such as a switch or router (e.g., through a network adapter).

The system 130 may be implemented in a number of different forms, as shown in FIG. 1. For example, it may be implemented as a standard server or multiple times in a group of such servers. Additionally, or alternatively, the system 130 may be implemented as part of a rack server system, a personal computer, such as a laptop computer, and/or the like. Alternatively, components from system 130 may be combined with one or more other same or similar systems and the user input system 140 may be made up of multiple computing devices communicating with each other.

FIG. 1 also illustrates a user input system 140, in accordance with an embodiment of the disclosure. The user input system 140 may include a processor 152, memory 154, an input/output device such as a display 156, a communication interface 158, and a transceiver 160, among other components, such as one or more image sensors. The user input system 140 may also be provided with a storage device, such as a microdrive and/or the like, to provide additional storage. Each of the components 152, 154, 158, and 160, may be interconnected using various buses, and several of the components may be mounted on a common motherboard or in other manners as appropriate.

The processor 152 may be configured to execute instructions within the user input system 140, including instructions stored in the memory 154. The processor 152 may be implemented as a chipset of chips that include separate and multiple analog and/or digital processors. The processor 152 may be configured to provide, for example, for coordination of the other components of the user input system 140, such as control of user interfaces, applications run by user input system 140, and/or wireless communication by user input system 140.

The processor 152 may be configured to communicate with the user through control interface 164 and display interface 166 coupled to a display 156. The display 156 may be, for example, a Thin-Film-Transistor Liquid Crystal Display (TFT LCD) or an Organic Light Emitting Diode (OLED) display, and/or other appropriate display technology. An interface of the display 156 may include appropriate circuitry and may be configured for driving the display 156 to present graphical and other information to a user. The control interface 164 may receive commands from a user and convert them for submission to the processor 152. In addition, an external interface 168 may be provided in communication with processor 152 to enable near area communication of user input system 140 with other devices. External interface 168 may provide, for example, for wired communication in some implementations, or for wireless communication in other implementations, and multiple interfaces may also be used.

The memory 154 may store information within the user input system 140. The memory 154 may be implemented as one or more of a computer-readable medium or media, a volatile memory unit or units, or a non-volatile memory unit or units. Expansion memory may also be provided and connected to user input system 140 through an expansion interface (not shown), which may include, for example, a Single In Line Memory Module (SIMM) card interface. Such expansion memory may provide extra storage space for user input system 140 and/or may store applications and/or other information therein. In some embodiments, expansion memory may include instructions to carry out or supplement the processes described above and/or may include secure information. For example, expansion memory may be provided as a security module for user input system 140 and may be programmed with instructions that permit secure use of user input system 140. Additionally, or alternatively, secure applications may be provided via the SIMM cards, along with additional information, such as placing identifying information on the SIMM card in a secure manner. In some embodiments, the user may use applications to execute processes described with respect to the process flows described herein. For example, one or more applications may execute the process flows described herein. In some embodiments, one or more applications stored in the system 130 and/or the user input system 140 may interact with one another and may be configured to implement any one or more portions of the various user interfaces and/or process flow described herein.

The memory 154 may include, for example, flash memory and/or NVRAM memory. In some embodiments, a computer program product may be tangibly embodied in an information carrier. The computer program product may contain instructions that, when executed, perform one or more methods, such as those described herein. The information carrier may be a computer-readable or machine-readable medium, such as the memory 154, expansion memory, memory on processor 152, and/or a propagated signal that may be received, for example, over transceiver 160 and/or external interface 168.

In some embodiments, the user may use the user input system 140 to transmit and/or receive information and/or commands to and/or from the system 130. In this regard, the system 130 may be configured to establish a communication link with the user input system 140, whereby the communication link establishes a data channel (wired and/or wireless) to facilitate the transfer of data between the user input system 140 and the system 130. In doing so, the system 130 may be configured to access one or more aspects of the user input system 140, such as, a GPS device, an image capturing component (e.g., camera), a microphone, a speaker, and/or the like.

The user input system 140 may communicate with the system 130 (and one or more other devices) wirelessly through communication interface 158, which may include digital signal processing circuitry. Communication interface 158 may provide for communications under various modes or protocols, such as GSM voice calls, SMS, EMS, or MMS messaging, CDMA, TDMA, PDC, WCDMA, CDMA2000, GPRS, and/or the like. Such communication may occur, for example, through transceiver 160. Additionally, or alternatively, short-range communication may occur, such as using a Bluetooth, Wi-Fi, and/or other such transceiver (not shown). Additionally, or alternatively, a Global Positioning System (GPS) receiver module 170 may provide additional navigation-related and/or location-related wireless data to user input system 140, which may be used as appropriate by applications running thereon, and in some embodiments, one or more applications operating on the system 130.

The user input system 140 may also communicate audibly using audio codec 162, which may receive spoken information from a user and convert it to usable digital information. Audio codec 162 may likewise generate audible sound for a user, such as through a speaker (e.g., in a handset) of user input system 140. Such sound may include sound from voice telephone calls, may include recorded sound (e.g., voice messages, music files, and/or the like) and may also include sound generated by one or more applications operating on the user input system 140, and in some embodiments, one or more applications operating on the system 130.

Various implementations of the systems and techniques described here may be realized in digital electronic circuitry, integrated circuitry, specially designed ASICs (application specific integrated circuits), computer hardware, firmware, software, and/or combinations thereof. Such various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and/or at least one output device.

Computer programs (e.g., also referred to as programs, software, applications, code, and/or the like) may include machine instructions for a programmable processor, and may be implemented in a high-level procedural and/or object-oriented programming language, and/or in assembly/machine language. As used herein, the terms “machine-readable medium” and/or “computer-readable medium” may refer to any computer program product, apparatus and/or device (e.g., magnetic discs, optical disks, memory, Programmable Logic Devices (PLDs), and/or the like) used to provide machine instructions and/or data to a programmable processor, including a machine-readable medium that receives machine instructions as a machine-readable signal. The term “machine-readable signal” may refer to any signal used to provide machine instructions and/or data to a programmable processor.

To provide for interaction with a user, the systems and/or techniques described herein may be implemented on a computer having a display device (e.g., a CRT (cathode ray tube), an LCD (liquid crystal display) monitor, and/or the like) for displaying information to the user, a keyboard by which the user may provide input to the computer, and/or a pointing device (e.g., a mouse or a trackball) by which the user may provide input to the computer. Other kinds of devices may be used to provide for interaction with a user as well. For example, feedback provided to the user may be any form of sensory feedback (e.g., visual feedback, auditory feedback, and/or tactile feedback). Additionally, or alternatively, input from the user may be received in any form, including acoustic, speech, and/or tactile input.

The systems and techniques described herein may be implemented in a computing system that includes a back end component (e.g., as a data server), that includes a middleware component (e.g., an application server), that includes a front end component (e.g., a client computer having a graphical user interface or a Web browser through which a user may interact with an implementation of the systems and techniques described here), and/or any combination of such back end, middleware, and/or front end components. Components of the system may be interconnected by any form or medium of digital data communication (e.g., a communication network). Examples of communication networks include a local area network (“LAN”), a wide area network (“WAN”), and/or the Internet.

In some embodiments, computing systems may include clients and servers. A client and server may generally be remote from each other and typically interact through a communication network. The relationship of client and server may arise by virtue of computer programs running on the respective computers and having a client-server relationship to each other.

The embodiment of the system environment 100 illustrated in FIG. 1 is exemplary and other embodiments may vary. As another example, in some embodiments, the system 130 includes more, less, or different components. As another example, in some embodiments, some or all of the portions of the system environment 100, the system 130, and/or the user input system 140 may be combined into a single portion. Likewise, in some embodiments, some or all of the portions of the system environment 100, the system 130, and/or the user input system 140 may be separated into two or more distinct portions.

In some embodiments, the system environment 100 may include one or more user input systems and/or one or more shipment monitoring systems (e.g., similar to the system 130 and/or the user input system 140) associated with an entity (e.g., a business, a merchant, a financial institution, a transportation management institution, a shipping company, and/or the like). For example, a user (e.g., an employee, a customer, and/or the like) may use a user input system (e.g., similar to the user input system 140) to monitor shipments tracked by one or more other applications (e.g., on one or more other systems similar to the system 130). In some embodiments, the user input system and/or the shipment monitoring system associated with the entity may perform one or more of the steps described herein.

As noted above, in some embodiments, the system may perform one or more of the functions described herein using AI and/or a machine learning model. For example, the system may provide data associated with supply chains, routes, schedules, shipping lanes, current situational data, and/or the like, to a lead time predicting machine learning model trained (e.g., using historical data associated with supply chains, routes, schedules, shipping lanes, situational data, and/or the like) to output predicted lead times of shipments. As another example, the system may provide data associated with supply chains, routes, schedules, shipping lanes, current situational data, and/or the like to an ETA prediction machine learning model trained (e.g., using historical data associated with supply chains, routes, schedules, shipping lanes, situational data, and/or the like) to output predicted ETAs of shipments. As yet another example, the system may provide data associated with supply chains, routes, schedules, shipping lanes, current situational data, and/or the like to an alternative path machine learning model trained (e.g., using historical data associated with supply chains, routes, schedules, shipping lanes, situational data, and/or the like) to output alternative paths (e.g., alternate modes, routes, and/or carrier options) that may be used to achieve a delivery time.

In some embodiments, the system may be configured to implement any of the following applicable machine learning algorithms either singly or in combination: supervised learning (e.g., using logistic regression, using back propagation neural networks, using random forests, decision trees, and/or the like), unsupervised learning (e.g., using an Apriori algorithm, using K-means clustering), semi-supervised learning, reinforcement learning (e.g., using a Q-learning algorithm, using temporal difference learning), and any other suitable learning style. Each module of the system may implement any one or more of: a regression algorithm (e.g., ordinary least squares, logistic regression, stepwise regression, multivariate adaptive regression splines, locally estimated scatterplot smoothing, and/or the like), an instance-based method (e.g., k-nearest neighbor, learning vector quantization, self-organizing map, and/or the like), a regularization method (e.g., ridge regression, least absolute shrinkage and selection operator, elastic net, and/or the like), a decision tree learning method (e.g., classification and regression tree, iterative dichotomiser 3, C4.5, chi-squared automatic interaction detection, decision stump, random forest, multivariate adaptive regression splines, gradient boosting machines, and/or the like), a Bayesian method (e.g., naïve Bayes, averaged one-dependence estimators, Bayesian belief network, and/or the like), a kernel method (e.g., a support vector machine, a radial basis function, a linear discriminant analysis, and/or the like), a clustering method (e.g., k-means clustering, expectation maximization, and/or the like), an associated rule learning algorithm (e.g., an Apriori algorithm, an Eclat algorithm, and/or the like), an artificial neural network model (e.g., a Perceptron method, a back-propagation method, a Hopfield network method, a self-organizing map method, a learning vector quantization method, and/or the like), a deep learning algorithm (e.g., a restricted Boltzmann machine, a deep belief network method, a convolution network method, a stacked auto-encoder method, and/or the like), a dimensionality reduction method (e.g., principal component analysis, partial least squares regression, Sammon mapping, multidimensional scaling, projection pursuit, and/or the like), an ensemble method (e.g., boosting, bootstrapped aggregation, AdaBoost, stacked generalization, gradient boosting machine method, random forest method, and/or the like), and any suitable form of machine learning algorithm. Each processing portion of the system may additionally or alternatively leverage a probabilistic module, heuristic module, deterministic module, or any other suitable module leveraging any other suitable computation method, machine learning method or combination thereof. However, any suitable machine learning approach may otherwise be incorporated in the system. Further, any suitable model (e.g., machine learning, non-machine learning, and/or the like) may be used in generating data relevant to the system. In some embodiments, the one or more machine learning algorithms may be predictive modeling algorithms configured to use data and statistics to predict outcomes with forecasting models.

In some embodiments, the machine learning models may be generated by training on data over a predetermined past period of time. In doing so, the system may be configured to output predicted lead times, predicted ETAs, alternative paths, and/or the like. In some embodiments, the one or more statistical methods may be used to calculate likelihoods of a delivery time being met by taking an alternative path, and whether the likelihood satisfies a threshold.

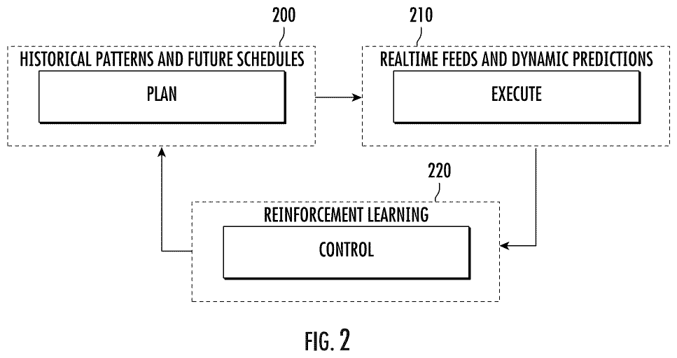

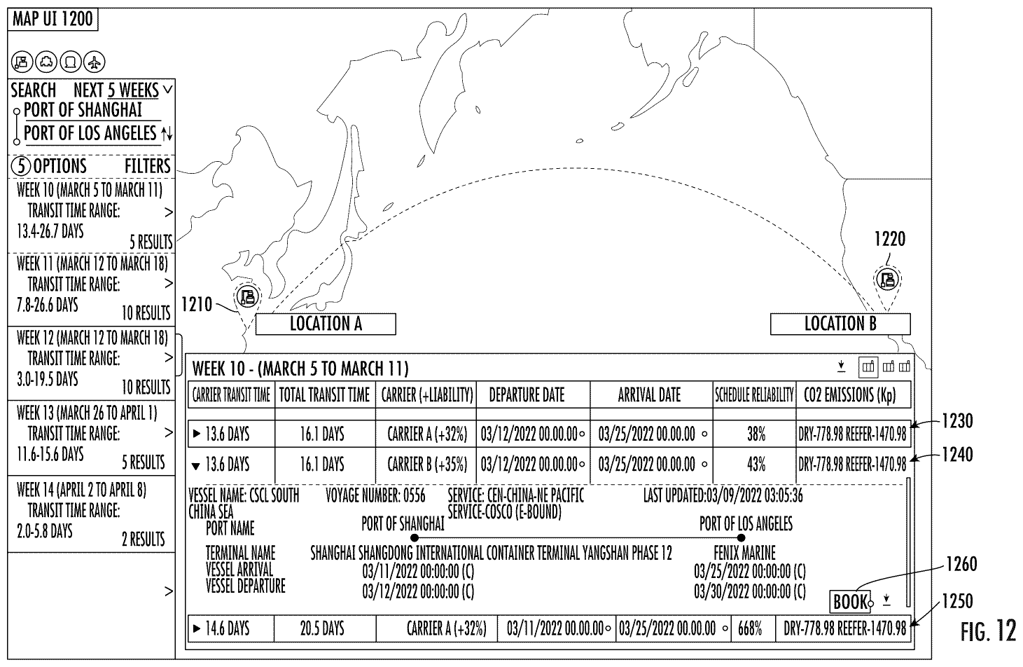

Referring now to FIG. 2, an example process framework is provided for monitoring and automatically controlling cargo transportation. As shown, in Block 200 of FIG. 2, the system process framework may use historical patterns as well as future schedules to generate one or more shipment routes for a shipment. The system may use the historical patterns relating to carrier information, location information, terminal information, traffic data, and/or the like. For example, as shown and described herein with respect to FIG. 12, each carrier may have a reliability rating based on past shipments that are used to estimate future shipments.

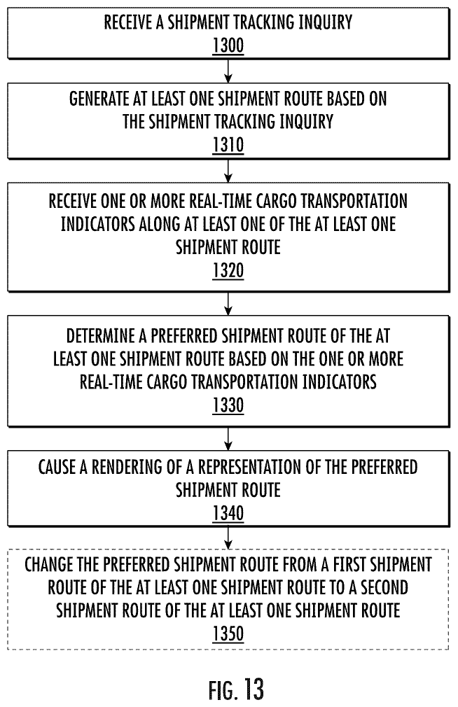

Additionally, as shown in Block 210 of FIG. 2, the system may use real-time feeds of data (e.g., real-time cargo transportation indicators as described herein with respect to FIG. 13) in order to make dynamic predictions about a given shipment route. For example, the system may determine that a specific shipment route is going to take a longer amount of time to complete due to congestion at one or more locations along the route.

As shown in Block 220 of FIG. 2, the system may use reinforcement learning (e.g., machine learning) to update and adjust shipment route selection and estimations, in real-time (e.g., updating a shipment route with more accurate predictions) and/or in future uses (e.g., teach a machine learning model to predict a better shipment route).

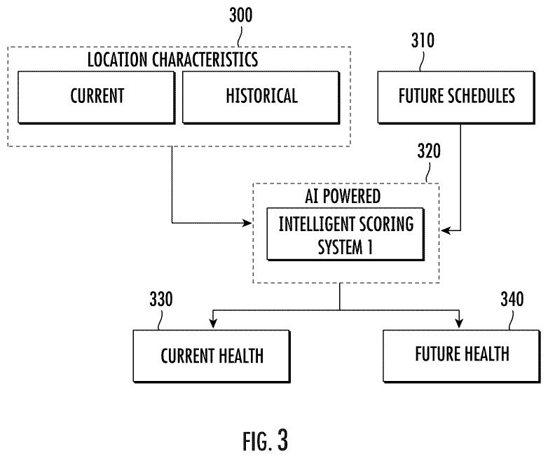

Referring now to FIG. 3, an example process framework is provided for determining and monitoring location health. A location may be any place in which a shipment can pass through during shipping. A location, such as a shipment hub or port, can often be a determining factor of route shipment timelines, as shipments can sometimes be stalled at a single location waiting for a transfer. Therefore, estimating the location health allows for estimated shipment route transit times to be more accurate. In order to estimate location health, the system may use location characteristics 300 (e.g., current and/or historical location characteristics) and/or future schedules 310. For example, Location A may traditionally take at least 1-2 days from the time a shipment arrives at the location before the shipment leaves the location. This historical information along with any current location characteristics can be used to estimate the location health. Continuing the example of Location A, the wait time may be 1-2 days, but the current location characteristics indicate that one or more ports at Location A are non-operational and therefore, the wait time will likely be higher than the typical 1-2 days.

Location characteristics can include operating hours, assets (e.g., the number of cranes, containers/chassis depots, and/or the like), interline connection, congestion (both on land and ocean), booking, weather patterns, workforce, import/export quantities, terminal capacity, local events, and/or the like. These location characteristics are used to calculate a location score (health). Additionally, the historical location characteristics can include time series patterns from historical data and seasonality. In some embodiments, the system may be capable to learn from random unforeseen events and can provide future location health predictions.

The system may also use future schedules to determine location health. For example, the system may analyze future schedules to determine whether a bottle neck may occur that would otherwise delay the shipment. The system can use future schedules of shipments and/or future weather forecasts to predict any deviations from the current location health. For example, a rainy season at a given location may lower the location health of a location due to rain likely causing delays.

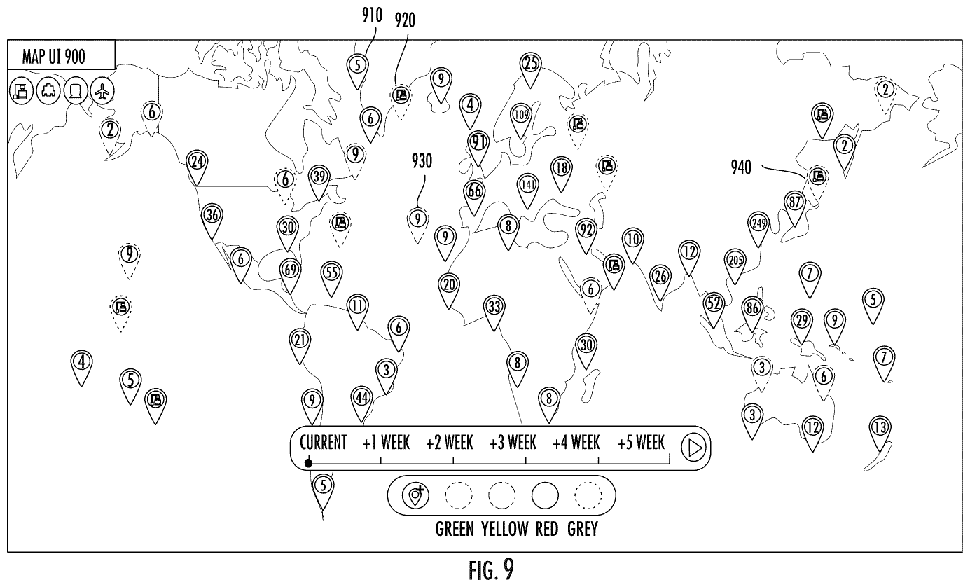

The system (as shown in Block 320) can determine a current location health 330 and/or a future location health 340 based on the location characteristics 300 and/or the future schedules. The location health may be calculated as a location health value. Various other factors may also be used to determine the location health. The location health may be categorized to illustrate the effect of the location on a shipment route. The location health may be a comparison to the typical delay time for a given location. For example, and as shown in FIG. 9, a given location may be labeled either red, green, or yellow, where red indicates a significant delay compared to the typical delay at that location, yellow indicates a slight delay compared to the typical delay at that location, and green indicates little to no delay compared to the typical delay at that location. Each category may have a threshold location health value that the system uses to determine the location health category for a given location. The same process can be used for subsets of a location (e.g., terminals within a location to determine a terminal health). This threshold may vary location to location.

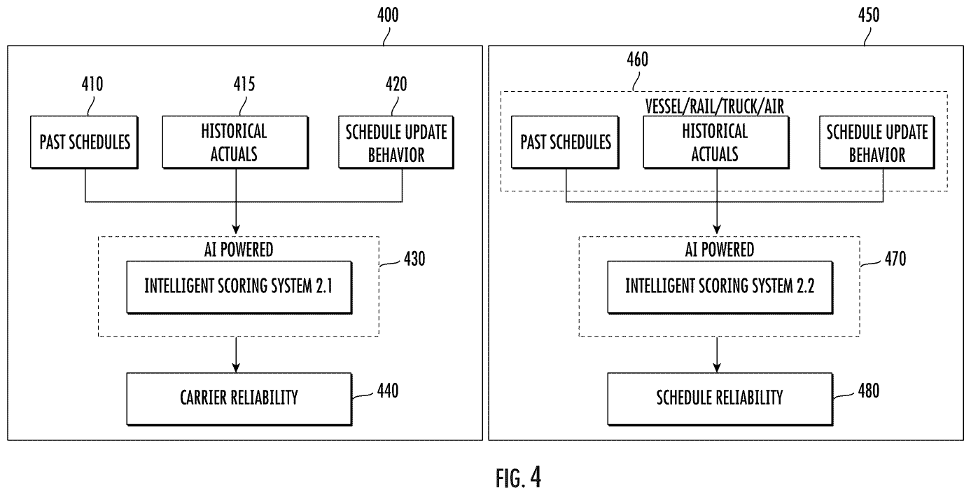

Referring now to FIG. 4, an example process framework is provided for determining shipment route reliability and carrier reliability. As shown in Block 400, the carrier reliability may be calculated using past schedules 410 (e.g., performance on previous shipment routes), historical carrier data (e.g., historical actuals 415), and/or schedule update behaviour 420 (e.g., changes to schedule and/or operations that may affect the future performance of the carrier). As such, as shown in Block 430, the system uses the operations described herein to determine a carrier reliability 440.

In a manner similar to that described herein with respect to determining a carrier reliability, a schedule reliability may also be determined for a shipment route, as shown in Block 450. The system may use past schedules, historical actuals (e.g., historical schedule data), and/or schedule update behaviour (e.g., block 460) to determine the reliability of a given scheduled shipment. For example, the system may determine the likelihood a shipment estimate is correct for a given shipment.

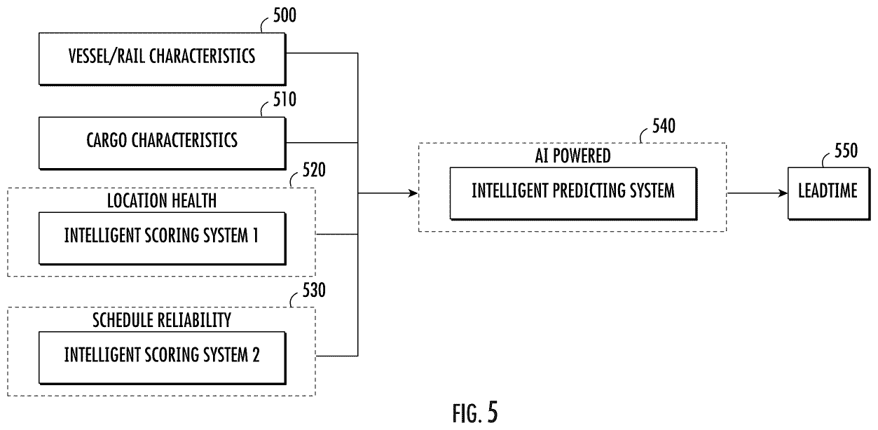

Referring now to FIG. 5, an example process framework is provided for determining product lead time based on shipment route estimates. The transportation type characteristics (e.g., vessel/rail characteristics 500), the cargo characteristics 510 (e.g., weight and shape of shipment), the location health 520) (e.g., as described herein with respect to FIG. 3), and/or the schedule reliability 530 (e.g., as described herein with respect to FIG. 4) may be used to determine the lead time 550 for a given shipment. For example, the above referenced characteristics may be used to provide an estimated delivery date or remaining transit time for a shipment. As shown in Block 540, the system may be capable of determining the lead time 550 using one or more processors described herein. Various other factors may also be processed by the system, such as carrier reliability, terminal health, weather conditions, seasonality, and/or the like when determining the lead time 550.

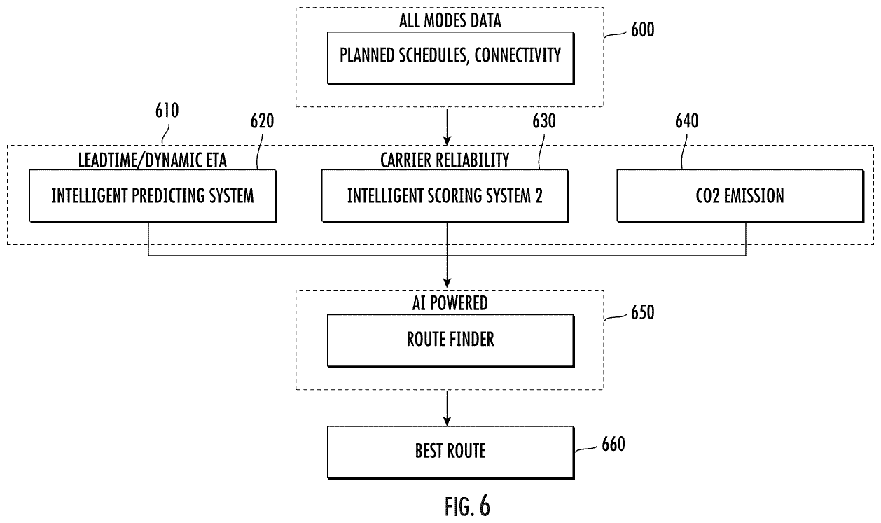

Referring now to FIG. 6, an example process framework is provided for determining a preferred shipment route. The system may use one or more of the calculated values discussed herein to determine a preferred (or best) shipment route. As shown, the system may use data output by one or more data models (e.g., Block 600) to produce one or more cargo transportation indicators, as shown in Block 610. For example, the system may determine an estimated lead time 620, a carrier reliability 630, and/or CO₂ emission estimations 640 for a given shipment route. The estimated lead time 620 may also include providing a dynamic ETA that can be updated during transit. As shown in Block 650, each of these calculated values may be provided to the system to determine one or more shipment routes for a given shipment. Based on the calculated values for each shipment route, the system is configured to determine the preferred route (e.g., best route 660). The preferred route may be based on carrier characteristics and/or reliability, industry related to shipment, cost of route, sustainability of route, and/or other shipment characteristics), various real-time tracking data, and/or various near real-time tracking data.

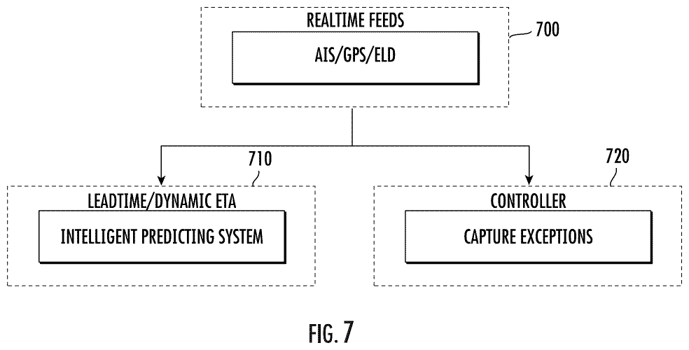

Referring now to FIG. 7, an example process framework is provided for performing real-time tracking of a shipment. As shown in Block 700, the system may receive real-time tracking data and/or near to real-time tracking data (e.g., automatic identification system (AIS) data, global position system (GPS) data, and/or electronic logging device (ELD) data). Various other tracking data may be used, such as car location message (CLM). The type of tracking data may be based on the transportation type. For example, AIS data can be used to track a vessel, CLM data can be used to track rail cars, and GPS data can be used to track over the road (OTR) cargo. The location of the shipment may be used to provide real-time tracking of a shipment, as well as updates to delivery estimates (e.g., a shipment may be behind schedule if the shipment has not reached a certain location by a certain time).

The tracking data may be used to update lead times and provide dynamic ETAs (e.g., Block 710) and/or to determine any issues with a shipment. For example, and as shown in Block 720, a shipment tracker may indicate that the shipment is offtrack and appropriate correction and/or review is needed for the shipment. Such review and/or correction may be completed manually and/or automatically (e.g., by the system, by another system in response to a command sent by the system, and/or the like).

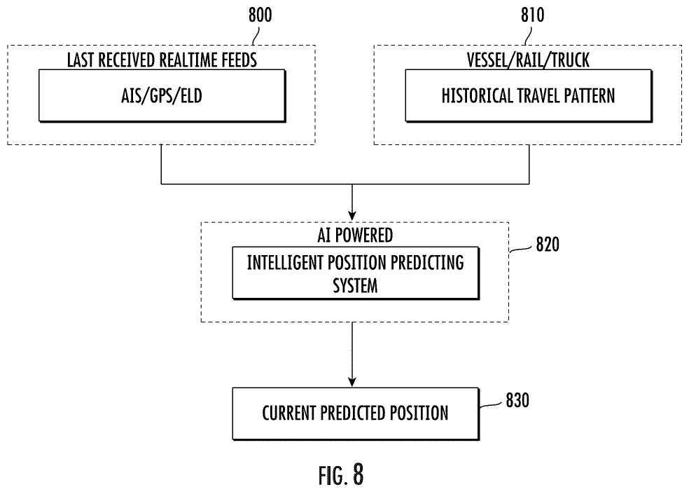

Referring now to FIG. 8, an example process framework is provided for performing real-time estimation of a shipment location. In some instances, the real-time tracking data may not be readily accessible and/or more not be continuously monitored. The system may be configured to estimate the current predicted position 830 of the shipment. For example, the system may receive the last received tracking data 800 (e.g., AIS, GPS, ELD, CLM, and/or the like) that indicates the last known location of the shipment. The time during which the shipment was at the given location may also be included. Additionally, or alternatively, the system may receive historical travel patterns 810, and the system may determine, based on the historical travel patterns 810, the current predicted position. For example, and as shown in Block 820, the system may use an AI to predict the current predicted position of the shipment based on the last received tracking data 800 and/or the historical travel patterns 810.

The user interface of a user device may display the current predicted position of the shipment for reference by a user. The user interface may also include the preferred shipment route and the position of the shipment along the preferred shipment route. The determination of the current predicted position of the shipment may use machine learning, based on previous shipments. Various factors may affect the current predicted position of the shipment, including, for example, shipment characteristics (e.g., whether the shipment is a hazmat shipment, a weight of the shipment, and/or the like).

Referring now to FIG. 9, an example user interface 900 illustrating the location health of a plurality of locations is provided. The user interface may include a map representation including a visual representation of the location health of a given location. For example, indicator 910 represents a location with significant delay compared to the typical delay at that location (e.g., a red icon at the given location), indicator 920 represents a location where the location health is unknown) (e.g., a grey icon at the given location), indicator 930 represents a location with slight delay compared to the typical delay at that location (e.g., a yellow icon at the given location), and indicator 940 represents a location with little to no delay compared to the typical delay at that location (e.g., a green icon at the given location). The indicators may also include additional information about the location health. Although red, grey, yellow, and green colors have been described herein as visual representations of particular values of location health, such colors may be used for different values of location health. Furthermore, other colors may be used as visual representations of particular values of location health. Additionally, or alternatively, visual representations of particular values of location health may be provided in other manners, such as via numerical ratings, shading, differently-shaped icons, and/or the like.

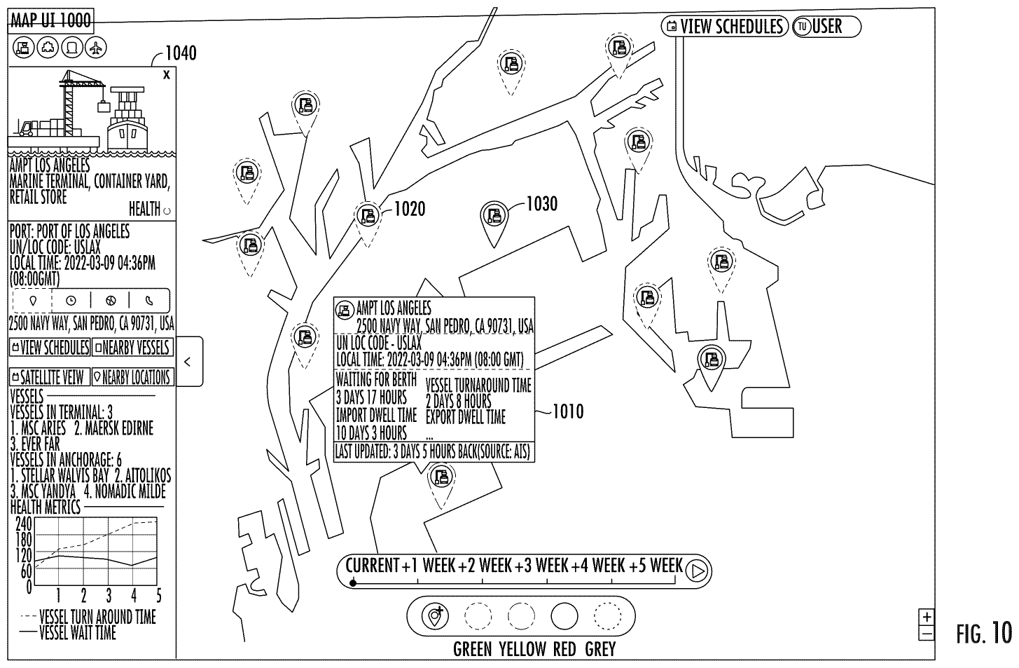

Referring now to FIG. 10, an example user interface 1000 illustrating the terminal health of a plurality of terminals is provided. A given location may have multiple terminals that each have individual terminal health ratings (e.g., a given terminal may be busier than another terminal at the same location). Therefore, the specific terminal within a location to which a shipment is assigned may affect a shipment prediction. Similar to the location health described herein with respect to FIG. 9, the terminal health of each terminal may be represented by an icon. For example, indicator 1010 indicates a slight delay compared to the typical delay at that location (e.g., yellow indicator), indicator 1020 indicates little to no delay compared to the typical delay at that location (e.g., green indicator), and indicator 1030 indicates a significant delay compared to the typical delay at that location (e.g., red indicator). As shown by indicator 1010, other information may also be provided relating to a given terminal, such as wait time, average turnaround, and/or the like. In some instances, a user device is capable of displaying such information about one or more terminals (e.g., by clicking on the indicator correlating to the given terminal). Although red, yellow, and green colors have been described herein as visual representations and/or icons of terminal health ratings, such colors may be used for different terminal health ratings. Furthermore, other colors may be used as visual representations and/or icons of terminal health ratings. Additionally, or alternatively, visual representations and/or icons of terminal health ratings may be provided in other manners, such as via numerical ratings, shading, differently-shaped icons, and/or the like.

The user interface portion 1040 illustrates additional information about a terminal, such as location information, historical health ratings, transport types in the given terminals (e.g., vessels in terminal), and/or the like. Various other information about one or more terminals may also be provided on the user interface 1000.

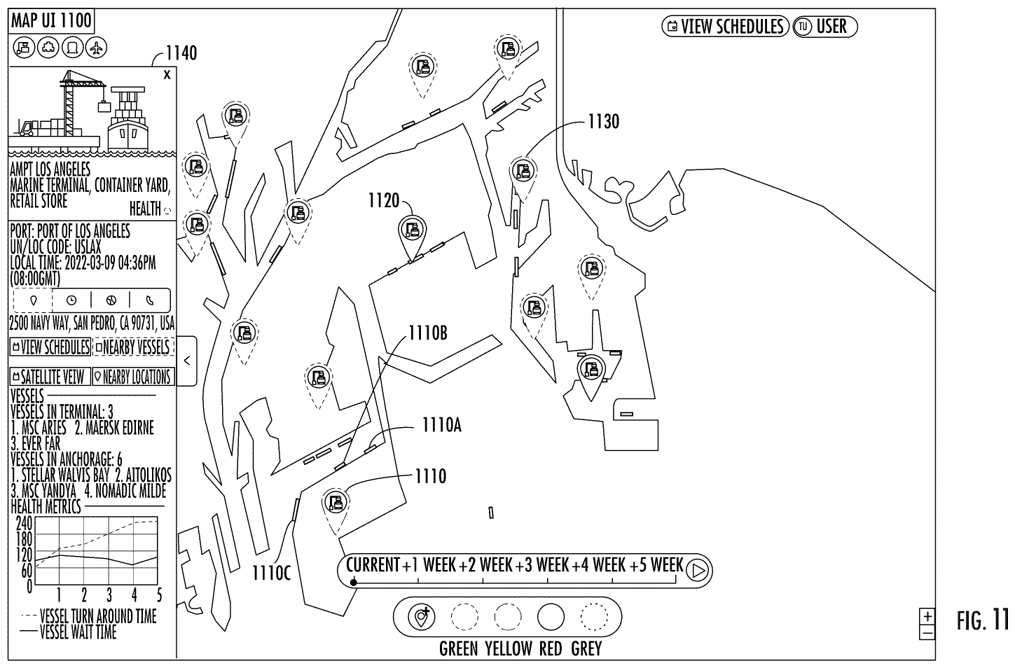

Referring now to FIG. 11, an example user interface 1100 illustrating the real-time tracking of the vessels at a given location is shown. In a manner similar to that described herein with respect to FIG. 10, the terminal health may be displayed for terminal(s) within a given location. Additionally, each terminal may have one or more positions for transports. For example, terminal 1110 may have three docking ports 1110A, 1110B, and 1110C. The user interface 1100 may include information on whether the given position for transport is occupied. The number of positions for transports may be used to determine the terminal health and/or the location health. For example, a busier terminal with more positions for transports may still have a relatively high terminal health due to be able to handle a higher capacity. Each terminal may have multiple positions for transport (e.g., each of terminals 1110, 1120, and 1130 have three positions of transport).

The user interface portion 1140 illustrates additional information about a terminal, such as location information, historical health ratings, transport types in the given terminals (e.g., vessels in terminal), and/or the like. Various other information about one or more terminals may also be provided on the user interface 1100.

Referring now to FIG. 12, an example user interface 1200 in which multiple potential shipment routes are provided is shown. As shown, the shipment is intended to be transported from Location A 1210 to Location B 1220. The system has generated three potential routes from Location A to Location B. Route 1230 is through Carrier A, Route 1240 is through Carrier B, and Route 1250 is also through Carrier A. Routes 1230 and 1240) have the same transit time, but Route 1240 has a higher schedule reliability (e.g., an estimation of the accuracy of the arrival date). This may be at least partially based on the higher reliability of Carrier B than Carrier A. Other factors considered to generate a reliability rating may include historical route performance, seasonality, and/or the like. Additionally, Route 1250 has a higher schedule reliability, but has a longer transit time. The map UI 1200 may display multiple route options for a user to select. For example, as shown by icon 1260, a user can book a given route (e.g., the user is selecting to book Route 1240). The preferred route may be updated to reflect the selected route. In some embodiments, a preferred route may be initially selected by the system and the user may be able to change to another shipment route via the interface shown.

FIG. 13 illustrates an example method of monitoring and automatically controlling cargo transportation. The method of FIG. 13 may include processes similar to and/or the same as other methods discussed herein, unless otherwise noted. The method may be carried out by a system discussed herein (e.g., the structure discussed in reference to FIG. 1). An example system may include at least one non-transitory storage device and at least one processing device coupled to the at least one non-transitory storage device. In such an embodiment, the at least one processing device is configured to carry out the method discussed herein.

Referring now to Block 1300 of FIG. 13, the method includes receiving a shipment tracking inquiry. The shipment tracking inquiry can include cargo characteristics (e.g., size, weight, quantity, and/or the like). The shipment tracking inquiry can also include an origination location and a destination location. The shipment tracking inquiry may be related to a purchase (e.g., a user may be purchasing or potentially purchasing a product and the shipment tracking inquiry is related to the delivery of the product to the user).

Referring now to Block 1310 of FIG. 13, the method includes generating at least one shipment route based on the shipment tracking inquiry. As discussed herein, the system is configured to determine at least one shipment route for the shipment based on the origination location and the destination location. The shipment route may be one or more shipment types, including, for example, rail transport, road transport, air transport, and/or water transport. In some instances, the shipment tracking inquiry may include a preferred transport type (e.g., the shipment may be desired to be delivered at least partially via air). Alternatively, the shipment tracking inquiry may indicate a desired delivery date (e.g., a user may purchase two-day shipping).

The shipment routes may be generated at least partially based on historical route information. The historical route information may include previous routes from the origination location to the destination location (and/or some subset between the origination location and the destination location). Various other route generation operations may be used to determine at least one of the shipment routes.

Each shipment route may have a shipment route reliability rating (e.g., schedule reliability discussed above) based on the various factors, such as carrier reliability, historical information, location health, and/or the like. The shipment route reliability rating may be used to determine an estimated shipment transit time.

Referring now to Block 1320 of FIG. 13, the method includes receiving one or more real-time cargo transportation indicators along at least one of the at least one shipment route. The one or more real-time cargo transportation indicators may include any of the data received that relates to a given shipment route that may affect an estimated shipment timeline. The real-time cargo transportation indicators may include information relating to at least one shipment along the given route (e.g., either a current shipment or past shipment along the route). Real-time cargo transportation indicators may include location health, terminal health, traffic data, seasonality, cargo characteristics, carrier reliability, and/or the like. For example, the real-time cargo transportation indicator(s) may indicate a status of one or more shipments on at least one of the at least one shipment route. The real-time cargo transportation indicator(s) can be based on real-time tracking data, such as global position system (GPS) data, automatic identification system (AIS) data, car location message (CLM) data, and/or the like.

Referring now to Block 1330 of FIG. 13, the method includes determining a preferred shipment route of the at least one shipment route based on the one or more real-time cargo transportation indicators. The system may be configured to determine a shipment route transit time estimate, which indicates the estimated transit time for the given shipment route. The system may also be configured to determine a route reliability rating, which indicates the confidence level of the shipment route transit time estimate. The route reliability rating may be affected by the route itself (e.g., weather and other delays), transportation type, and/or the carrier executing the route.

Based on the shipment route transit time estimate and/or the route reliability rating, the system may select a preferred shipment route for the shipment. In some instances, the preferred shipment may be based on the fastest route (e.g., shortest estimated transit time). Additionally or alternatively, the preferred shipment may be based on the reliability rating (e.g., a user may prefer to use a more reliable shipment route to ensure the shipment is delivered by a given date). Various other factors may also be used to determine the preferred shipment route (e.g., the shortest distance, the least emissions produced, and/or the like). Additionally, a user may be able to select which preferred shipment route selection to use as default (e.g., the user may prefer for the system to always select the quickest shipment route).

In some instances, the system may be configured to cause a rendering of a display with information relating to one or more of the shipment route(s). For example, as shown in FIG. 12, the user interface 1200 may display one or more potential shipment routes for selection by a user. For example, the system may receive a route selection input that selects one of the potential shipment route options. In some embodiments, the preferred shipment route may be updated based on the route selection input. For example, the user may select a shipment route and the preferred shipment route will be updated to be the shipment route. In some instances, the user interface may indicate the preferred shipment route to the user (e.g., the preferred shipment route may be the first shipment route listed).

Referring now to Block 1340 of FIG. 13, the method includes causing a rendering of a representation of the preferred shipment route. The user interface described herein may be configured to render various representations of a map (e.g., one or more of the UIs shown and described herein with respect to FIGS. 9-12). As shown in FIG. 12, the UI may provide an illustration of a shipment route (e.g., the dotted line between Location A 1210 and Location B 1220). In various embodiments, the user interface may also include information relating to location health, terminal health, shipment route information, and/or the like.

The representation of the preferred shipment route may be updated to represent the shipment location along the given route. The shipment location may be determined using real-time tracking (e.g., as shown in FIG. 7) and/or current predicted position (e.g., as shown in FIG. 8). The representation of the preferred shipment route may also be dynamically updated based on any changes to the preferred shipment route (e.g., if a preferred shipment route changes, a shipment is delayed along the shipment route, and/or the like).

Referring now to optional Block 1350 of FIG. 13, the method may include changing the preferred shipment route from a first shipment route of the at least one shipment route to a second shipment route of the at least one shipment route. The preferred shipment route may be dynamically updated based on changes to the route. The preferred shipment route may be dynamically updated based on one or more real-time cargo transportation indicators. For example, a given location along the preferred route may have a downgraded location health, which would delay the transit time of the shipment, which causes other shipment routes to be faster or otherwise preferred over the current preferred shipment route.

In an example embodiment, the system is configured to determine at least one location-based performance indicator (e.g., location health, terminal health, and/or the like) for one or more locations. The location-based performance indicator indicates the time taken for one or more shipments travelling through the given location and/or terminal. The location-based performance indicator may be used to update the preferred route. For example, in an instance in which the location health of a location along a shipment route changes, the shipment route transit time estimate may also change; therefore, the system may determine whether the preferred shipment route is still preferred over other potential shipment routes (e.g., a shipment route that is longer in distance may be shorter timewise due to a location along the route having little to no delay).

The method of monitoring and automatically controlling cargo transportation described herein with respect to FIG. 13 may include additional embodiments, such as any single embodiment or any combination of embodiments described herein and/or in connection with one or more other processes, methods, and/or systems described elsewhere herein. Although FIG. 13 shows example blocks of the method, in some embodiments, the method may include additional blocks, fewer blocks, different blocks, or differently arranged blocks than those depicted in FIG. 13. Additionally, or alternatively, two or more of the blocks of the method may be performed in parallel.

As will be appreciated by one of ordinary skill in the art in view of this disclosure, the present disclosure may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present disclosure may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present disclosure may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present disclosure, however, the computer-readable medium may be transitory, such as, for example, a propagation signal including computer-executable program code portions embodied therein.

One or more computer-executable program code portions for carrying out operations of the present disclosure may include object-oriented, scripted, and/or unscripted programming languages, such as, for example, Java, Perl, Smalltalk, C#, C++, SAS, SQL, Python, Objective C, JavaScript, and/or the like. In some embodiments, the one or more computer-executable program code portions for carrying out operations of embodiments of the present disclosure are written in conventional procedural programming languages, such as the “C” programming languages and/or similar programming languages. The computer program code may alternatively or additionally be written in one or more multi-paradigm programming languages, such as, for example, F #.

Some embodiments of the present disclosure are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that may direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present disclosure.

Although many embodiments of the present disclosure have just been described above, the present disclosure may be embodied in many different forms and should not be construed as limited to the embodiments set forth herein: rather, these embodiments are provided so that this disclosure will satisfy applicable legal requirements. Also, it will be understood that, where possible, any of the advantages, features, functions, devices, and/or operational aspects of any of the embodiments of the present disclosure described and/or contemplated herein may be included in any of the other embodiments of the present disclosure described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

Some implementations may be described herein in connection with thresholds. As used herein, satisfying a threshold may, depending on the context, refer to a value being greater than the threshold, more than the threshold, higher than the threshold, greater than or equal to the threshold, less than the threshold, fewer than the threshold, lower than the threshold, less than or equal to the threshold, equal to the threshold, or the like.

While certain exemplary embodiments have been described and shown in the accompanying drawings, it is to be understood that such embodiments are merely illustrative of and not restrictive on the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments may be configured without departing from the scope and spirit of the disclosure. Therefore, it is to be understood that the disclosure may be practiced other than as specifically described herein.

1. A system for monitoring and automatically controlling cargo transportation, the system comprising:
at least one non-transitory storage device; and
at least one processing device coupled to the at least one non-transitory storage device, wherein the at least one processing device is configured to:
receive a shipment tracking inquiry, wherein the shipment tracking inquiry comprises at least an origination location and a destination location;
generate at least one shipment route based on the shipment tracking inquiry;
receive one or more real-time cargo transportation indicators along at least one of the at least one shipment route, wherein the one or more real-time cargo transportation indicators indicate a status of one or more shipments on at least one of the at least one shipment route;
based on the one or more real-time cargo transportation indicators, determine a preferred shipment route of the at least one shipment route, wherein the preferred shipment route is at least one of a fastest route of the at least one shipment route or a shortest route of the at least one shipment route; and
cause a display device to display a rendering of a representation of the preferred shipment route.

2. The system of claim 1, wherein a first shipment route of the at least one shipment route is at least one of a first shipment type and a second shipment route of the at least one shipment route is at least one of a second shipment type, wherein the first shipment type is different from the second shipment type.

3. The system of claim 2, wherein the first shipment type and the second shipment type are each at least one of a rail transport, a road transport, an air transport, or a water transport.

4. The system of claim 1, wherein the one or more real-time cargo transportation indicators includes at least one of a route information for another shipment along the at least one shipment route.

5. The system of claim 1, wherein the at least one processing device is further configured to determine a shipment route reliability rating for the at least one shipment route based on at least one historical shipment indicator relating to the at least one shipment route or carrier of the at least one shipment route.

6. The system of claim 1, wherein the at least one processing device is further configured to change the preferred shipment route from a first shipment route of the at least one shipment route to a second shipment route of the at least one shipment route based on one or more real-time cargo transportation indicators.

7. The system of claim 1, wherein the at least one processing device is further configured to:
determine at least one location-based performance indicator for one or more locations, wherein each location-based performance indicator indicates a time taken for one or more shipments travelling through a given location of the one or more locations; and
based on at least one of the at least one location-based performance indicator, update the preferred shipment route.

8. The system of claim 7, wherein the at least one processing device is further configured to cause a rendering of a display of the at least one location-based performance indicator for at least one of the one or more locations.

9. The system of claim 1, wherein the at least one processing device is further configured to:
cause a rendering of a display comprising information relating to at least one of the at least one shipment route; and
receive a route selection input that selects one of the at least one shipment route in the rendering, wherein the preferred shipment route is updated based on the route selection input.

10. The system of claim 1, wherein at least one of the one or more real-time cargo transportation indicators is based on global position system (GPS) data, automatic identification system (AIS) data, car location message (CLM) data, or electronic logging device (ELD) data.

11. A computer program product for monitoring and automatically controlling cargo transportation, the computer program product comprising at least one non-transitory computer-readable medium having computer-readable program code portions embodied therein, the computer-readable program code portions comprising:
an executable portion configured to receive a shipment tracking inquiry, wherein the shipment tracking inquiry comprises at least an origination location and a destination location;
an executable portion configured to generate at least one shipment route based on the shipment tracking inquiry;
an executable portion configured to receive one or more real-time cargo transportation indicators along at least one of the at least one shipment route, wherein the one or more real-time cargo transportation indicators indicate a status of one or more shipments on at least one of the at least one shipment route;
an executable portion configured to determine a preferred shipment route of the at least one shipment route based on the one or more real-time cargo transportation indicators, wherein the preferred shipment route is at least one of a fastest route of the at least one shipment route or a shortest route of the at least one shipment route; and
an executable portion configured to cause a display device to display a rendering of a representation of the preferred shipment route to a user interface.

12. The computer program product of claim 11, wherein a first shipment route of the at least one shipment route is at least one of a first shipment type and a second shipment route of the at least one shipment route is at least one of a second shipment type, wherein the first shipment type is different from the second shipment type.

13. The computer program product of claim 12, wherein the first shipment type and the second shipment type are each at least one of a rail transport, a road transport, an air transport, or a water transport.

14. The computer program product of claim 11, wherein the one or more real-time cargo transportation indicators includes at least one of a route information for another shipment along the at least one shipment route.

15. The computer program product of claim 11, wherein the computer-readable program code portions include an executable portion configured to a shipment route reliability rating for the at least one shipment route based on at least one historical shipment indicator relating to the at least one shipment route or carrier of the at least one shipment route.

16. (canceled)

17. (canceled)

18. (canceled)

19. (canceled)

20. (canceled)

21. A computer-implemented method for monitoring and automatically controlling cargo transportation, the method comprising:
receiving a shipment tracking inquiry, wherein the shipment tracking inquiry comprises at least an origination location and a destination location;
generating at least one shipment route based on the shipment tracking inquiry;
receiving one or more real-time cargo transportation indicators along at least one of the at least one shipment route, wherein the one or more real-time cargo transportation indicators indicate a status of one or more shipments on at least one of the at least one shipment route;
based on the one or more real-time cargo transportation indicators, determining a preferred shipment route of the at least one shipment route, wherein the preferred shipment route is at least one of a fastest route of the at least one shipment route or a shortest route of the at least one shipment route; and
causing a display device to display a rendering of a representation of the preferred shipment route.

22. The method of claim 21, wherein a first shipment route of the at least one shipment route is at least one of a first shipment type and a second shipment route of the at least one shipment route is at least one of a second shipment type, wherein the first shipment type is different from the second shipment type.

23. The method of claim 22, wherein the first shipment type and the second shipment type are each at least one of a rail transport, a road transport, an air transport, or a water transport.

24. The method of claim 21, wherein the one or more real-time cargo transportation indicators includes at least one of a route information for another shipment along the at least one shipment route.

25. The method of claim 21, further comprising determining a shipment route reliability rating for the at least one shipment route based on at least one historical shipment indicator relating to the at least one shipment route or carrier of the at least one shipment route.

26. (canceled)

27. (canceled)

28. (canceled)

29. (canceled)

30. (canceled)
